(19) United States
(12) Patent Application Publication
(10) Pub. No.: US 2024/0175384 A1
(43) Pub. Date: May 30, 2024

(54) DEVICE FOR EXHAUST-GAS TREATMENT AND METHOD FOR THE PRODUCTION THEREOF

(71) Applicant: Vitesco Technologies GmbH, Regensburg (DE)

(72) Inventors: Peter HIRTH, Rösrath (DE); Thomas HÄRIG, Neunkirchen-Seelscheid (DE)

(21) Appl. No.: 18/283,521

(22) PCT Filed: Dec. 22, 2021
(86) PCT No.: PCT/EP2021/087184

§ 371 Date: Sep. 22, 2023

(30) Foreign Application Priority Data
Mar. 24, 2021 (DE) 10 2021 202 901.9

(51) Int. Cl. F01N 3/20; B01D 53/94; F01N 3/28; F24H 3/00

(52) U.S. Cl. CPC F01N 3/2026; B01D 53/94; F01N 3/2803; F24H 3/002; B01D 2258/01; F01N 2510/068; F24H 2250/02

(57) ABSTRACT

A device for heating up an exhaust gas flowing in an exhaust gas line, including a heating disk having at least one electrical conductor arranged along a conductor path. Air gaps are formed between individual sections of the electrical conductor. The heating disk is connected to a disk-like support element in an electrically insulated manner by supports. The disk-like support element has at least one web, which forms a rigid holder for the supports. The disk-like support element has at least one cutout which is in alignment with at least one of the air gaps along a main throughflow direction of the device and through which the exhaust gas can flow.

### CROSS REFERENCE TO RELATED APPLICATIONS

This is a U.S. national stage of Application No. PCT/EP2021/087184 filed Dec. 22, 2021. Priority is claimed on German Application No. DE 10 2021 202 901.9 filed Mar. 24, 2021, the content of which is incorporated herein by reference.

### BACKGROUND OF THE INVENTION

### 1. Field of the Invention

The disclosure relates to a device for heating up an exhaust gas flowing in an exhaust gas line, comprising a heating disk, wherein the heating disk has at least one electrical conductor arranged along a conductor path, wherein air gaps are formed between individual sections of the electrical conductor, wherein the heating disk is connected to a disk-like support element in an electrically insulated manner by a support. Furthermore, the disclosure relates to a method for producing such a device.

### 2. Description of the Related Art

To improve exhaust gas purification in an internal combustion engine, different catalytic converters are used in the exhaust gas tract. To enable exhaust gas aftertreatment to be as early and complete as possible, it is necessary to reach a so-called light-off temperature of the respective catalytic converters as quickly as possible. The light-off temperature is specific to each catalytic converter and is determined, among other things, by the respective structure, the material used or the selected catalytically active coating. The light-off temperature describes the limit temperature from which the catalytic converter is fully functional and sufficiently converts the corresponding constituent parts of the exhaust gas. It is necessary to heat up the exhaust gas via electrical heating elements particularly during low-load operation or after cold starting.

A device for heating up the exhaust gas flow or the catalytic converters arranged in the exhaust gas tract are known in various forms in the prior art. In particular, honeycomb bodies are known that are designed as a heating disk with a limited axial extent and are connected to a voltage source so that they can be heated using ohmic resistance. The exhaust gas flowing around the heating disk is thus heated, as a result of which catalytic converters through which the exhaust gas subsequently flows are also heated. The light-off temperature is thus reached much earlier than in a non-electrically heated exhaust gas system.

### SUMMARY OF THE INVENTION

An aspect of the present invention is to create a device for exhaust gas aftertreatment, in particular for heating up an exhaust gas flowing in an exhaust gas line, it being possible for a washcoat to be applied completely and with high quality to the device and the device at the same time having a sufficiently high stability for further processing. The object of the invention is also to create a method for producing the device.

One aspect of the invention relates to a device for heating up an exhaust gas flowing in an exhaust gas line, comprising a heating disk, wherein the heating disk has at least one electrical conductor which is arranged along a conductor path, wherein air gaps are formed between individual sections of the electrical conductor, wherein the heating disk is connected to a disk-like support element in an electrically insulated manner by a support, wherein the disk-like support element has at least one web which forms a rigid holder for the support, wherein the disk-like support element has at least one cutout which is in alignment with at least one of the air gaps along a main throughflow direction of the device and through which the exhaust gas can flow.

The heating disk has at least one electrical conductor. The electrical conductor is connected to a voltage source and heat can thus be generated using the ohmic resistance. The electrical conductor can preferably be formed by a metallic honeycomb body formed, for example, from a plurality of metal foils that are stacked one on the other and wound up to form a stack of layers. However, the electrical conductor can also be formed by a wire or another electrically conductive body.

Metallic honeycomb bodies in heating disks are known in a wide variety of forms in the prior art. They have a plurality of channels through which media can flow along a main throughflow direction from a first end side, which represents a gas inlet side, to a second end side, which represents a gas outlet side.

An exhaust gas analogously flows around an electrical conductor, which is designed as a wire, from a gas inlet side, which is formed by an end side, to a gas outlet side, which is also formed by an end side.

The electrical conductor, regardless of type, is arranged inside the heating disk along a so-called conductor path. In the case of a metallic honeycomb body, the conductor path is produced, for example, by winding up the stack of layers. Depending on the winding technique, a honeycomb body rolled up in an S-shape can be created, for example. In the case of a wire as the electrical conductor, any arrangement can be chosen. The conductor can run in one plane or in several planes arranged parallel to one another.

In order to avoid short circuits between the individual sections of the conductor, an air gap is provided between the sections of the conductor. This is necessary because optimum heating up can only take place when the applied current flows as uniformly as possible through the entire conductor and thus the conductor is heated up as homogeneously as possible. Short circuits between individual sections of the conductor can result in unwanted current conduction, resulting in uneven heat generation and furthermore also possibly having an adverse effect on the functionality of the entire heating disk. Due to the air gaps, the individual sections of the conductor are substantially spaced apart from one another in the radial direction.

In order to electrically insulate the electrical conductor from the remaining components of the device, a so-called support used, which can also have an additional fixing effect. Support pins with an electrically non-conductive core, for example composed of an oxide ceramic, are common and known. In the case of a honeycomb body, support pins can be inserted into individual channels of the honeycomb body through which media can flow and can thus be connected to the honeycomb body. For this purpose, the support pins can have metallic coatings, for example, or can be inserted into metal sleeves, which can then in turn be inserted into the channels of the honeycomb body and connected to the honeycomb body.

A spatial distance from other electrically conductive structures is generated via the support. Furthermore, current conduction paths along the support are prevented by appropriate construction of the support.

In a simple embodiment, a support element can be a sheet-metal element. This support element is used to hold the support, which is connected to the electrical conductor of the heating disk. The support element thus forms a frame, which serves to stabilize the electrical conductor. This is particularly advantageous since electrical conductors, both metallic honeycomb bodies and wires, fundamentally do not have sufficient stability to withstand the steps required for assembly without being damaged. In particular, coating of the electrical conductor with a suitable coating, a so-called washcoat, is a process which produces mechanical stress and inevitably leads to unwanted deformation of an unsupported electrical conductor.

The support element is arranged adjacent and parallel to one of the end sides, preferably the gas inlet side, of the heating disk and is spaced apart from the heating disk by the support.

The support element preferably has at least one cutout. The support element particularly preferably has a plurality of cutouts which allow media to flow through the support element without hindrance as far as possible. In relation to the heating disk held by the support element, the support element is preferably designed to be substantially thinner.

The main throughflow direction means the direction of flow of the exhaust gas along which it flows through the heating disk. This is generally from one end side to the other end side. The direction of flow thus preferably runs along an axial direction of a housing in which the heating disk is arranged.

It is particularly advantageous when the disk-like support element is connected to a disk-like air guide plate on the side facing away from the heating disk, wherein the air guide plate has a plurality of bores which are in alignment with the cutout in the disk-like support element and/or at least one of the air gaps along the main throughflow direction of the device and through which the exhaust gas can flow.

The air guide plate is a plate which is substantially closed over the entire cross section of the device through which media can flow and considerably limits the flow of exhaust gas through the device. For the purpose of generating a directed flow of exhaust gas, the air guide plate has bores that allow media to flow through the air guide plate. The bores preferably have a diameter of a few millimeters and act like nozzles here.

The bores are arranged in such a way here that they are in alignment with the cutout or the cutouts in the support element and with the air gap or the air gaps in the heating disk along the main throughflow direction and thus media can flow in a straight line through the device through the bores in the air guide plate, the support element and the heating disk.

The bores thus direct the exhaust gas from the side of the air guide plate facing away from the heating disk to the side of the air guide plate facing the heating disk. From there, the exhaust gas flows virtually freely and, in particular, is not limited in the radial direction by guide structures. Due to the comparatively small diameter of the bores, however, this flow of exhaust gas is considerably accelerated and strongly directed, so that the flow of exhaust gas spreads preferably and to a much greater extent along an axial direction or the main throughflow direction than in a radial direction running transversely thereto.

The device according to an aspect of the invention is intended, in particular, for use in a heating device which has the purpose of heating up the exhaust gas. For this purpose, firstly, the exhaust gas is heated by flowing over the surface of the electrical conductor and, secondly, fuel is added to the exhaust gas flow in the heating device, this fuel being split or vaporized into shorter-chain compounds due to contact with the electrically heatable conductor, as a result of which an additional heating effect can be generated.

Gas flows through the heating device from a gas inlet, through the bores in the air guide plate along the cutouts in the support element, along the air gaps in the heating disk, to a baffle plate. Fuel can be admixed with the flow of exhaust gas there at the baffle plate. The exhaust gas mixture then flows through the heating disk parallel to the main throughflow direction but in the opposite direction, then preferably through the channels formed by the honeycomb body, and again through the cutouts in the support element. Finally, the exhaust gas mixture flows out of the heating device through a gas outlet.

It is also advantageous when the support element is of pot-shaped design, wherein a rim encircling in the circumferential direction extends from the support element in the direction of the heating disk. The support element can have, for example, one or more electrical bushings in the rim, it being possible for electrical contact to be made with the electrical conductor via the one or more electrical bushings. This is particularly important since the device according to an aspect of the invention is arranged in a housing which acts as a flow channel. Such a housing can be formed, for example, by a tubular body of an exhaust gas line.

A preferred exemplary aspect is characterized in that the at least one web of the support element has a plurality of clearances along which exhaust gas can flow through the support element. In order to further increase the ability of media to flow through the support element and to keep the adverse effect on the flow of exhaust gas as small as possible, the web or the webs formed in the support element can also have individual or multiple clearances. Overall, the support element should have as high a porosity as possible in order to allow media to flow through it easily. At the same time, the support element has to have sufficient rigidity to form a stable frame for the electrical conductor. Furthermore, the support element has to have a large enough surface to securely hold the supports of the electrical conductor.

It is also preferable when the end side of the heating disk facing the support element is spaced apart from the support element by the support at a distance of greater than 0.

Furthermore, the subject matter according to an aspect of the invention is characterized in that the electrical conductor forming the heating disk is not dimensionally stable. The lack of dimensional stability is due to the basic structure of the heating disk. A honeycomb body produced from metal foils by stacking them one on the other and winding them up does not have a high degree of stability when considered on its own. In particular, the effects of force on the honeycomb body lead to unwanted deformation. This applies analogously to wound-up wires or wires arranged in some other way.

Since, in particular, applying a washcoat to the electrical conductor is a process which produces mechanical stress and, in addition, very precise alignment of the air gaps and the channels in the honeycomb body has to be ensured for optimum functioning of the device, it is particularly important for the electrical conductor to be stabilized by a sufficiently stable support element.

An exemplary aspect of the invention relates to a method for producing a device for heating up an exhaust gas in an exhaust gas line, comprising a heating disk, comprising a support element and comprising an air guide plate, wherein, in a first production step, the heating disk is connected to the support element via the support and, in a second production step, a washcoat is applied to the electrical conductor of the heating disk, wherein the support element, which is connected to the heating disk, is connected to the air guide plate in a third production step.

The heating disk is preferably connected to the support element by a soldering process, wherein the support pins are permanently connected to the electrical conductor and the support element. The electrical conductor of the heating disk is thus dimensionally stable due to the connection to the support element, which acts as a frame, and can thus be processed further without becoming mechanically deformed.

The washcoat is then applied to the electrical conductor in order to create a catalytically active surface. The exact composition of the material used as a washcoat can preferably be adapted to the respective application. Washcoats with a variety of compositions are already known in the prior art for this purpose.

The air guide plate is durably connected to the support element as a production step that follows the coating with the washcoat. In particular, the two elements are welded to each other.

Furthermore, it is advantageous when the washcoat is applied to the electrical conductor by a suction method or by being blown on, wherein the washcoat is placed on one of the end sides of the heating disk and sucked through the heating disk by a suction method or is blown into the heating disk by a blowing-on process.

Methods for coating honeycomb bodies or another electrical conductor with a washcoat are known in the prior art. The principle here is that the washcoat is either blown through the honeycomb body or sucked through the honeycomb body. Excess material can be suctioned off, blown off or shaken off mechanically.

It is also expedient when the excess material of the washcoat that does not adhere to the electrical conductor of the heating disk is removed from the heating disk in a further production step by being suctioned off or blown off, wherein this production step takes place before the third production step.

The heating disk is therefore completely coated before the air guide plate is connected, this making coating considerably easier and contributing to a substantially higher process quality. In particular, the washcoat is prevented from remaining unintentionally on the heating disk. Furthermore, blocking of the flow channels formed in the honeycomb body is also prevented. Due to the high quality of the coating, a particularly large active surface is produced on the heating disk overall, this improving the heating up of the exhaust gas flowing past. In addition, the catalytically active area is increased in size in this way, as a result of which the chemical processes can take place more easily and intensely.

Furthermore, it is advantageous when the heating disk is connected to the support element by a soldering process. Furthermore, it is expedient when the support element is connected to the air guide plate by a welding process.

It is also advantageous when the heating disk, which is connected to the support element, is placed into an auxiliary housing for the purpose of applying the washcoat, in order to create a radial boundary for the washcoat and to produce a closed-off housing for blowing on or sucking in the washcoat.

Advantageous developments of the present invention are described in the dependent claims and in the description of the figures that follows.

### BRIEF DESCRIPTION OF THE DRAWINGS

The invention is explained in detail below on the basis of exemplary embodiments with reference to the drawings, in which:

FIG. 1 is an exploded illustration of a device, with the air guide plate, the support element and the honeycomb body forming the heating disk;

FIG. 2 is a further exploded illustration, with the support element having additional clearances, unlike the embodiment in FIG. 1; and

FIG. 3 is the support element, with the support element being pot-shaped.

### DETAILED DESCRIPTION OF THE PRESENTLY PREFERRED EMBODIMENTS

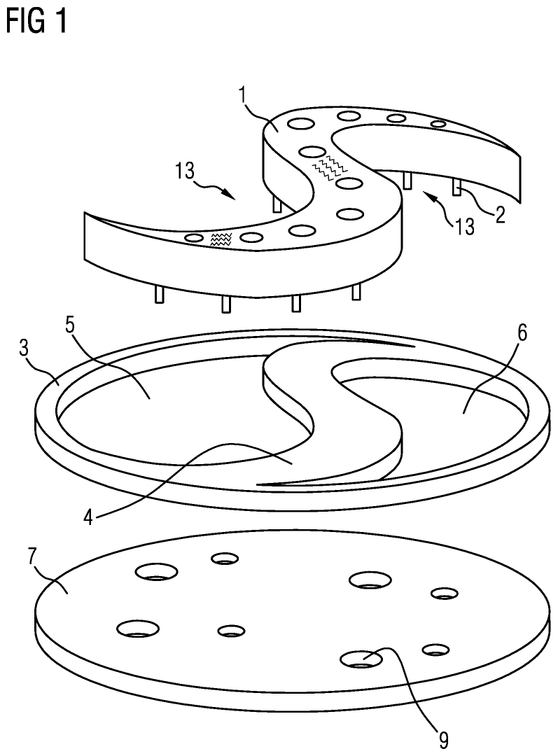

FIG. 1 shows a heating disk 1 formed from a metallic honeycomb body that has a plurality of channels through which media can flow. In the exemplary embodiment in FIG. 1, the heating disk 1 is formed in an s-shape by the stack of layers being wound up. The unfilled regions located between the electrical conductors forming the heating disk 1 form air gaps 13.

Supports 2 are inserted in the heating disk 1 and are formed by support pins known from the prior art. The support element 3 serves to hold the supports 2, as a result of which the heating disk 1 is connected to the support element 3. The heating disk is preferably soldered to the supports 2 and the supports 2 are preferably soldered to the support element 3.

As can be seen in FIG. 1, the support element 3 has a web 4, which is modeled on the shape of the heating disk 1. The two cutouts 5, 6 allow media to flow through the support element 3 over a large area.

With regard to the use of the device in a heating device, as has been described above, the exhaust gas flowing from top to bottom toward the support element 3 in FIG. 1 would be deflected in a radial direction after flowing through the heating disk 1, as a result of which exhaust gas would no longer substantially flow through the support element 3 itself at least in the case of return flow of the exhaust gas. It is therefore primarily important for the flow from the air guide plate 7 to the heating disk 1 to be adversely affected as little as possible by the cutouts 5, 6.

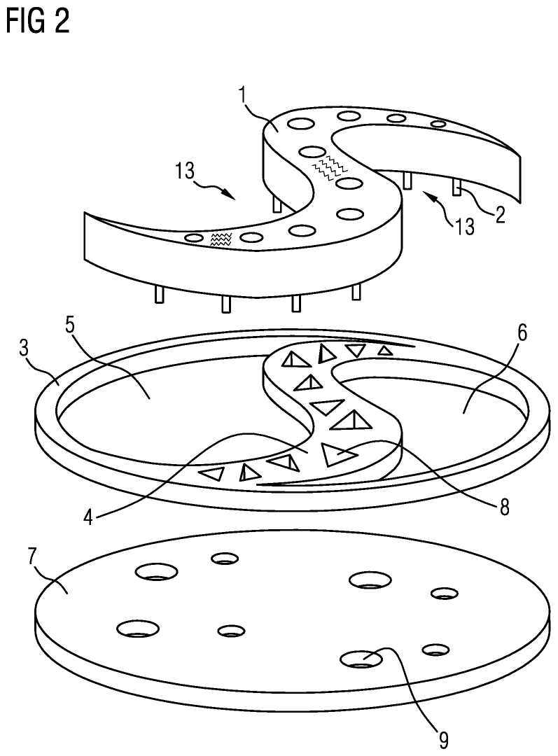

FIG. 2 shows a very similar structure to FIG. 1, and therefore the reference signs for identical features also correspond. In contrast to FIG. 1, the support element 3 additionally has clearances 8, which make it even easier for media to flow through. The more clearances 8 the support element 3 has, the higher its porosity, as a result of which throughflow is improved. However, it is essential to ensure that the support element 3 is sufficiently stable.

Both FIGS. 1 and 2 show an air guide plate 7, which has bores 9. The air guide plate 7 is ultimately used in the heating device to direct the flow of exhaust gas. As already described above, the exhaust gas flows onto a side of the air guide plate 7 facing away from the heating disk 1 and is guided from there, only through the bores 9, to the heating disk 1. The air guide plate 7 is of disk-shaped design.

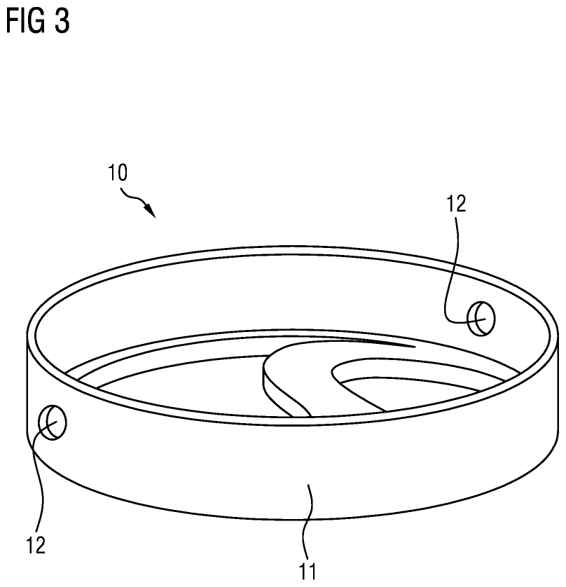

FIG. 3 shows an alternative configuration of a support element 10. The support element 10 here has a pot-shaped structure, which is produced by a rim 11 encircling in the circumferential direction and extending in the direction of the heating disk, not shown. The rim 11 can additionally have electrical bushings 12 through which an electrical conductor can be routed from the outside to the heating disk, as a result of which contact can be made with the electrical conductor forming the heating disk.

In addition, the rim 11 is helpful for coating the heating disk with the washcoat since the rim 11 limits the spread of the washcoat in the radial direction. In addition, the rim 11 helps to generate a positive pressure and/or a negative pressure for blowing in or sucking out the washcoat.

The different features of the individual exemplary embodiments can also be combined with one another. The exemplary embodiments of FIGS. 1 to 3 have, in particular, no limiting character and serve to illustrate the concept of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A device configured to heat an exhaust gas flowing in an exhaust gas line, comprising:
a heating disk, having at least one electrical conductor arranged along a conductor path, wherein air gaps are formed between individual sections of the at least one electrical conductor;
at least one support; and
a support element, which is disk-like, to which the heating disk is connected in an electrically insulated manner by the at least one support,
wherein the support element has at least one web that forms a rigid holder for the at least one support, and
wherein the support element has at least one cutout which is in alignment with at least one of the air gaps along a main throughflow direction of the device and through which the exhaust gas can flow.

14. The device as claimed in claim 13, wherein the support element is connected to a air guide plate, which is disk-like, on a side facing away from the heating disk, wherein the air guide plate has a plurality of bores which are in alignment with the at least one cutout in the support element and/or at least one of the air gaps along the main throughflow direction of the device and through which the exhaust gas can flow.

15. The device as claimed in claim 13, wherein the support element is of pot-shaped design, wherein a rim encircling in a circumferential direction extends from the support element in a direction of the heating disk.

16. The device as claimed in claim 13, wherein the at least one web of the support element has a plurality of clearances along which exhaust gas can flow through the support element.

17. The device as claimed in claim 13, wherein an end side of the heating disk facing the support element is spaced apart from the support element by the at least one support at a distance of greater than 0.

18. The device as claimed in claim 13, wherein the at least one electrical conductor forming the heating disk is not dimensionally stable.

19. A method for producing a device configured to heat an exhaust gas in an exhaust gas line, having a heating disk, a support element, and an air guide plate, comprising:
connecting the heating disk to the support element via at least one support;
applying a washcoat is to an electrical conductor of the heating disk; and
connecting the support element, which is connected to the heating disk, to the air guide plate.

20. The method for producing a device as claimed in claim 19,
wherein the washcoat is applied to the electrical conductor by a suction method or by being blown on,
wherein the washcoat is placed on one end side of the heating disk and drawn through the heating disk by a suction method or is blown into the heating disk by a blowing-on process.

21. The method for producing a device as claimed in claim 20, wherein excess material of the washcoat that does not adhere to the electrical conductor of the heating disk is removed from the heating disk by being suctioned off or blown off, wherein this takes place before connecting the support element to the air guide plate.

22. The method for producing a device as claimed in claim 19, wherein the heating disk is connected to the support element by a soldering process.

23. The method for producing a device as claimed in claim 19, wherein the support element is connected to the air guide plate by a welding process.

24. The method for producing a device as claimed in claim 19, wherein the heating disk, which is connected to the support element, is placed into an auxiliary housing for applying the washcoat, to create a radial boundary for the washcoat and to produce a closed-off housing for blowing on or drawing in the washcoat.
